(19) United States
(12) Patent Application Publication
(10) Pub. No.: US 2007/0287327 A1
(43) Pub. Date: Dec. 13, 2007

(54) Sensitive electrical wall outlet

(76) Inventor: Rezarta Pejo, Bethesda, MD (US)

Correspondence Address: REZARTA PEJO, 5816 GREEN TREE RD, BETHESDA, MD, 20817, US

(21) Appl. No.: 11/449,033

(22) Filed: Jun. 8, 2006

(51) Int. Cl. H01R 13/60

(52) U.S. Cl. 439/535

(57) ABSTRACT

The sensitive electrical wall outlet is designed to replace some of the usually found in our homes. The device is provided with a rear portion having a printed circuit in the lower part and a plug receptacle in the upper part and with a front portion having a transparent lens in the lower part. The printed circuit includes a photo conductive cell sensitive to the light through the lens. The cell is designed to become more conductive in the dark and less conductive in daylight. We can use this device for getting light in the bathroom, closet, hallway, kid's bedroom, or for Christmas lights, which needed to turn on in the dark and off when the day will comes. In these cases this sensitive plug will help to turn the light on and off automatically not manually as we are doing until now.

### BACKGROUND OF THE INVENTION

Electrical plug outlet is provided for getting power from the wall outlet to a thousand electrical devices. However, these devices must be manually switches on or left to burn continuously, or must be unplugged.

### BRIEF SUMMARY OF THE INVENTION

The present invention can be plugged into a wall outlet either directly or provided with an extension cord for the purpose. At this sensitive outlet device can be plugged every type of night-lights, landscape lights, decorations light and ornaments which we use for Christmas, Halloween . . . etc, that needs to start working when the dark will come and stop working when will be light. So every device that will be plugged to this new unit will turn on and off automatically when the dark will comes and goes.

The unit has a printed circuit board, a transparent lens in the lower part and e plug receptacle that is mounted in the upper part of the device The circuit includes a photo conductive cell sensitive to the light passing through the lens. Thus, as the ambient gets dark, the photo cell allows more and more current flow to the gate and the power at the plug receptacle will gradually gets bigger and bigger.

### BRIEF DESCRIPTION OF THE SEVERAL VIEWS OF THE DRAWING

In the drawing:

FIG. 1 is a perspective view, of a Sensitive electrical wall outlet presenting my invention;

FIG. 2 is a front view;

FIG. 3 is a side view;

FIG. 4 is a rear view;

FIG. 5 is a top view;

FIG. 6 is a bottom view;

FIG. 7 is a section on line 1-1 (left view) on FIG. 2

FIG. 8 is a section on line 1-1 (right view) on FIG. 2

FIG. 9 is a section on line 2-2 (rear portion view) on FIG. 3

FIG. 10 is a section on line 2-2 (front portion view) on FIG. 3

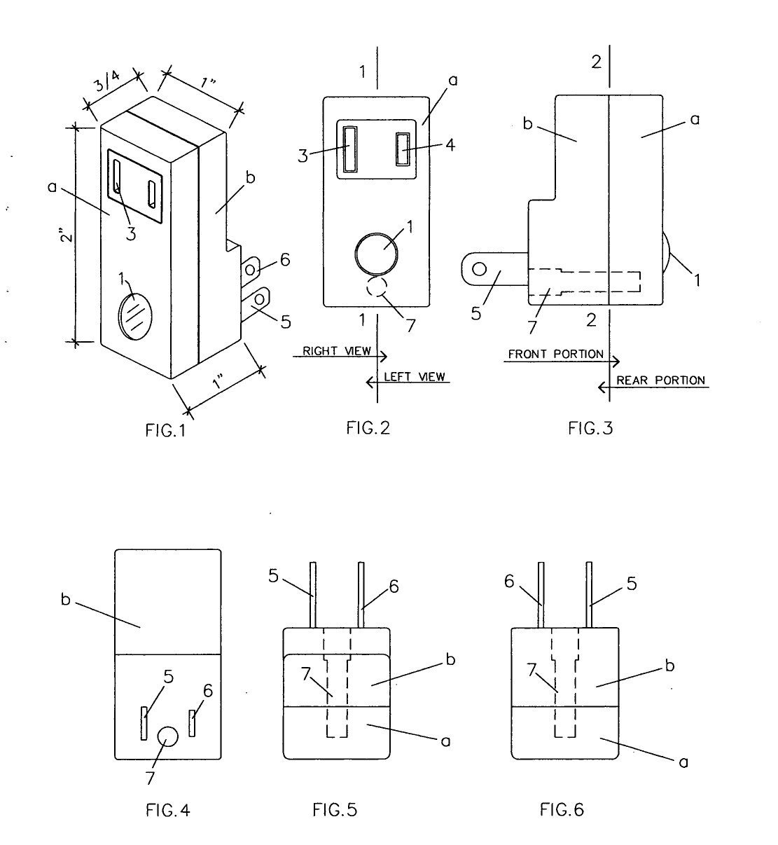

### DESCRIPTION OF THE INVENTION

The Sensitive electrical wall device of the present invention is provided with a front portion (a) of a generally rectangular form. At the lower part of the portion (a) is mounted a transparent lens 1. At the upper part of the portion (a) the device can be provided with the conventional plug receptacle 3 and 4 for plugging all the devices into this invented outlet. At the lower part of portion (a) is a no through (one side) hole 7, which will use for screwing two portions (a) and (b) together.

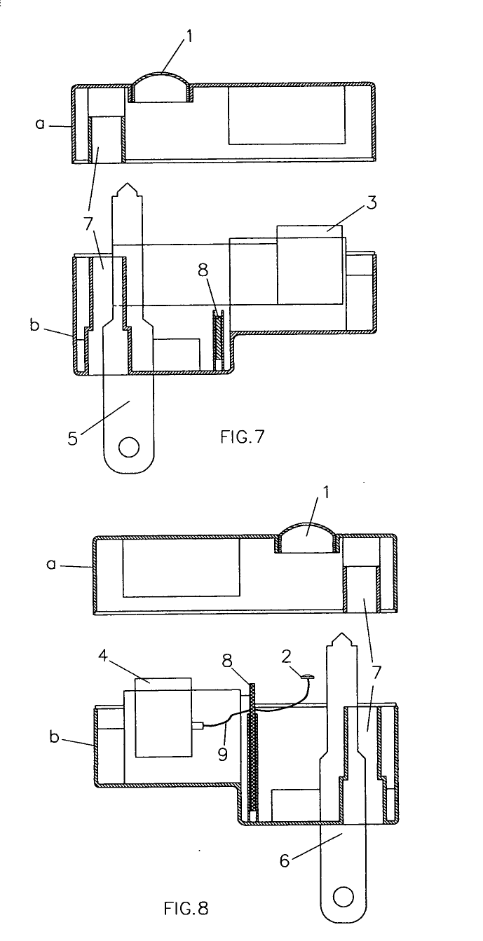

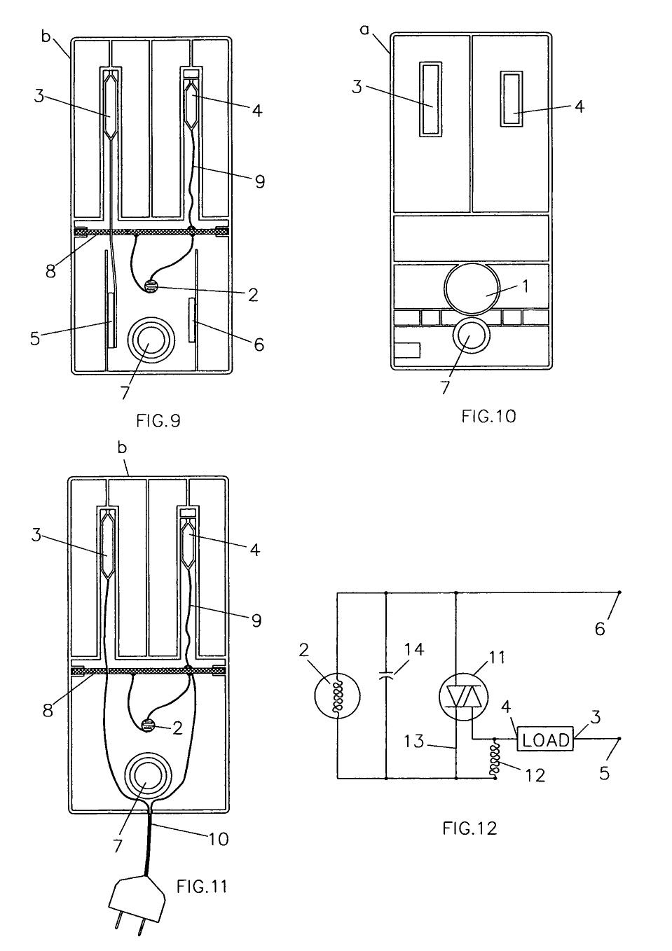

At the lower part of the portion (b) is a printed circuit board 8. Viewing FIG. 7, 8, and 9, the current to the plug receptacle 3 and 4 is provided from the contact by the receptacle 3 to one side of the power socket 5. The contact of the receptacle 4 with the board 8 is provided through a short piece of wire 9. FIG. 9 also, shows the cds (cadmium sulfide) photo conductive cell 2 mounted on the board. The conductive cell 2 is mounted on the board directly behind the transparent lens 1. At the rear of lower part of the portion (b), the device will be provided with the conventional contact blades 5 and 6 for plugging the device directly into a wall outlet, or the device can be provided with an extension cord 10 for the purpose as shown in FIG. 11.

At the lower part of portion (b) is a hole 7 that can use to screw two portions (a) and (b) together. The hole goes side to side through the portion (b).

Operation of the device is the same with the conventional “Night-light sensitive” that is using in our homes. The device is plugged into a source of alternating current and the ground line goes to the electrical plug receptacle instead to go to the electric light what happened in the printed circuit board provided for the existing “Night light sensitive”

So, the simple circuit serves to control the power of the electrical plug outlet 3 and 4 and cause it to increase the power as the ambient gets dark and to decrease the power as the ambient gets light. For all the devices that will be plugged at this new unite, no manual switching is necessary since the photocell 2 controls the current. The entire device is no larger than a conventional electrical wall outlet. The new device is provided with the same material as the other conventional plug outlets. The entire unit is comparatively inexpensive to manufacture. Its uses are needed and simple. Using this new unit can have possibility to save money and electricity.

Operation of the device is in accordance with the diagram shown in FIG. 12, mostly mounted on the printed circuit board 8. The device is plugged into a source of alternating current at 5 and 6. The ground line 5 goes to the LOAD, which in this case is an electrical plug receptacle 3. The other side 4 of the plug device goes to a quadric 11. The quadric goes back to the current supply source 6. The current to the plug receptacle 4 is controlled by the quadric 11 which in turn is triggered through the line 13 leading to the gate. The resistor 12 is a safety bypass to prevent damage to the parts in the case the lights that will be plugged in the plug device, burns out. The power line 6 is extended to one side of the cell 2 and the other side of the cell is connected to the gate lane 13. A capacitor 14 is mounted between the cell 2 and the quadric 11. The photo conductive cell 2 allows the current to flow to the gate line 13 as the ambient gates dark. The quadric 11 allows the current to flow through lines through the plug device.

I claim:

1. A sensitive electrical wall plug connector to replace in some cases the ordinary plugs that we are using. This device has front, rear, sides, top, and bottom wall portions, an electrical printed circuit with a photo conductive cell sensitive to the light through the lens and an electrical receptacle plug connected with each-other. That means as device receives light increases throughout the lens, said being characterized by the absence of need for a power source other than that it is connected. Otherwise, as the said received decrease light throughout the lens, the sensitive electrical wall outlet gets power bigger and bigger because of the photo conductive cell that it has.
The device including two portions. The rear portion and the front portion. These two portions are screws together through rear side. The screw opening is located in the lower part of the device.
The rear portion contains the printed circuit with the photo conductive cell and double plug receptacle connections.
The front portion contains: a small round transparent lens in the lower part and the electrical plug.

2. According to claim 1, said device is characterized by the absence of need for a power source in the daylight, other than that is plugged in the wall outlet.

3. According to claim 1, said device is characterized by the existence of need for a power source in the dark, when is plugged in the wall outlet.
